(19) United States
(12) Patent Application Publication
(10) Pub. No.: US 2010/0265347 A1
(43) Pub. Date: Oct. 21, 2010

(54) METHODS, ELECTRONIC DEVICES, AND COMPUTER PROGRAM PRODUCTS FOR ENCODING IMAGE FILES TO FACILITATE BROWSING THEREOF

(75) Inventor: Andreas Thor Agvard, Lomma (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/424,857

(22) Filed: Apr. 16, 2009

(51) Int. Cl. H04N 5/228; G06K 9/36

(52) U.S. Cl. 348/222.1; 382/233; 348/E05.031

(57) ABSTRACT

An electronic device is operated by receiving a first image file, generating a second image file by encoding the first image file using an encoding technique such that it is less complex to decode the second image file than it is to decode the first image file, and associating the first image file with the second image file.

### BACKGROUND OF THE INVENTION

The present invention relates to electronic devices and methods and computer program products for operating the same and, more particularly, to electronic devices, methods, and computer program products for encoding/decoding image files for improved browsing.

Image browsing on electronic devices, such as mobile terminals, may be relatively slow due to image decoding being a processor intensive process for many types of image formats. One technique to improve image browsing performance is to include a thumbnail version of an image that has a smaller size and can be decoded faster. Unfortunately, decoding Joint Photographic Experts Group (JPEG) encoded thumbnail images may still be relatively slow, for example, around 100 ms per image, which may limit fast browsing applications, such as touch screen browsing, unless relatively expensive hardware is incorporated into the device for image decoding.

### SUMMARY OF THE INVENTION

According to some embodiments of the present invention, an electronic device is operated by receiving a first image file, generating a second image file by encoding the first image file using an encoding technique such that it is less complex to decode the second image file than it is to decode the first image file, and associating the first image file with the second image file.

In other embodiments, the electronic device comprises a camera and wherein receiving the first image file comprises taking a picture with the camera, the picture being output from the camera as the first image file.

In still other embodiments, receiving the first image file comprises receiving the first image file via a communication connection established between the electronic device and another entity.

In still other embodiments, the first image file is encoded using Joint Photographic Experts Group (JPEG) encoding.

In still other embodiments, the encoding technique used to generate the second image file is Ericsson Texture Compression (ETC) encoding.

In still other embodiments, associating the first image file with the second image file comprises storing the first image file using a file format having a metadata tag for storing the second image file.

In still other embodiments, the file format is the Exchangeable Image File Format (EXIF) and the metadata tag is the MakerNote tag.

In still other embodiments, associating the first image file with the second image file comprises storing the second image file in a data structure and/or database that comprises a reference to the first image file.

In still other embodiments, the method further comprises receiving a request for a thumbnail view of the first image file and generating the thumbnail view of the first image file by decoding the second image file.

In still other embodiments, the electronic device is a mobile terminal.

In still other embodiments, a computer program product for operating an electronic device comprises a computer readable storage medium having computer readable program code embodied therein, the computer readable program code being configured to carry out one or more of the method described above.

In further embodiments of the present invention, an electronic device comprises a processor configured to receive a first image file, generate a second image file by encoding the first image file using an encoding technique such that it is less complex to decode the second image file than it is to decode the first image file, and to associate the first image file with the second image file.

In still further embodiments, the electronic device further comprises a camera and the processor is further configured to take a picture with the camera, the picture being output from the camera as the first image file.

In still further embodiments, the processor is further configured to receive the first image file via a communication connection established between the electronic device and another entity.

In still further embodiments, the first image file is encoded using Joint Photographic Experts Group (JPEG) encoding.

In still further embodiments, the encoding technique used to generate the second image file is Ericsson Texture Compression (ETC) encoding.

In still further embodiments, the processor is further configured to store the first image file using a file format having a metadata tag for storing the second image file.

In still further embodiments, the file format is the Exchangeable Image File Format (EXIF) and the metadata tag is a MakerNote tag.

In still further embodiments, the processor is further configured to receive a request for a thumbnail view of the first image file and to generate the thumbnail view of the first image file by decoding the second image file.

In still further embodiments, the electronic device is a mobile terminal

Other electronic devices, methods, and/or computer program products according to embodiments of the invention will be or become apparent to one with skill in the art upon review of the following drawings and detailed description. It is intended that all such additional electronic devices, methods, and computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a block diagram of an electronic device that includes an image encoding/decoding module that can provide improved image browsing in accordance with some embodiments of the present invention:

FIG. 2 is a block diagram of a mobile terminal that includes an image encoding/decoding module that can provide improved image browsing in accordance with some embodiments of the present invention; and

FIGS. 3 and 4 are flowcharts that illustrate operations of the electronic device/mobile terminal of FIGS. 1 and 2 in accordance with some embodiments of the present invention.

### DETAILED DESCRIPTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a GPS receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device that is capable of encoding image files to improve the decoding thereof, such as, for example, encoding image files such a manner that they can be decoded faster.

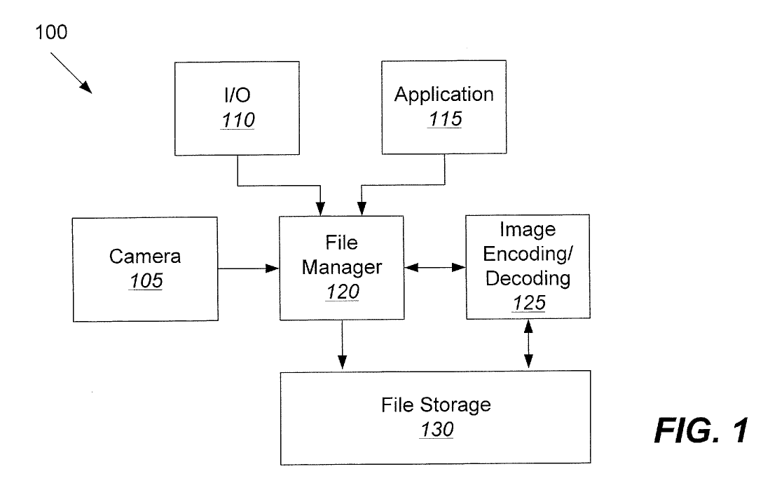

Referring to FIG. 1, an electronic device 100 that can provide improved image encoding/decoding, in accordance with some embodiments of the present invention, comprises a camera 105, an Input/Output (I/O) module 110, and an application 115 that communicate with a file manager 120 to provide image files to the file manager 120. For example, the camera 105 may be used to take a picture and generate an output file of the image in the Exchangeable Image File Format (EXIF). EXIF supports various file formats including, but not limited to, the Joint Photographic Experts Group (JPEG) format, the Tagged Image File Format (TIFF), and the Resource Interchange File Format (RIFF). The I/O module 110 may allow image files to be transferred to the electronic device 100 via a communication connection established with another entity. For example, in some embodiments, image files on another device may be communicated to the electronic device 100 via a Universal Serial Bus (USB) or other I/O interface standard. The application module 115 may also be used to provide image files to the file manager. For example, in some embodiments, the application module 115 may be an electronic mail application in which images may be associated with emails. It will be understood that the foregoing non-limiting examples of receiving image files at the file manager 120 are merely exemplary. The file manager 120 may receive image files in other ways in accordance with various embodiments of the present invention.

As discussed above, decoding JPEG image files, for example, may be relatively time consuming, which may be impractical for some image browsing applications, such as touch screen browsing. According to some embodiments of the present invention, the file manager 120 may provide image files to an image encoding/decoding module 125 which may encode the image files using an encoding technique that is less complex to decode than the technique used to encode the original image file. For example, the image encoding/decoding module 125 may encode a JPEG image file using Ericsson Texture Compression (ETC), which is less complex to decode than the original JPEG image file. The encoded image file may be provided to the file manager 120 and/or stored in the file storage unit 130. The file manager 120 may associate the original image file with the encoded version of the image file and store both files in the file storage unit 130. In some embodiments, the file manager 120 may store the encoded version of the image file in a metadata field of the original image file. When a request to browse the original image or view a thumbnail of the original image is received, the image encoding/decoding module 125 may decode the encoded version of the image file for presentation on a display.

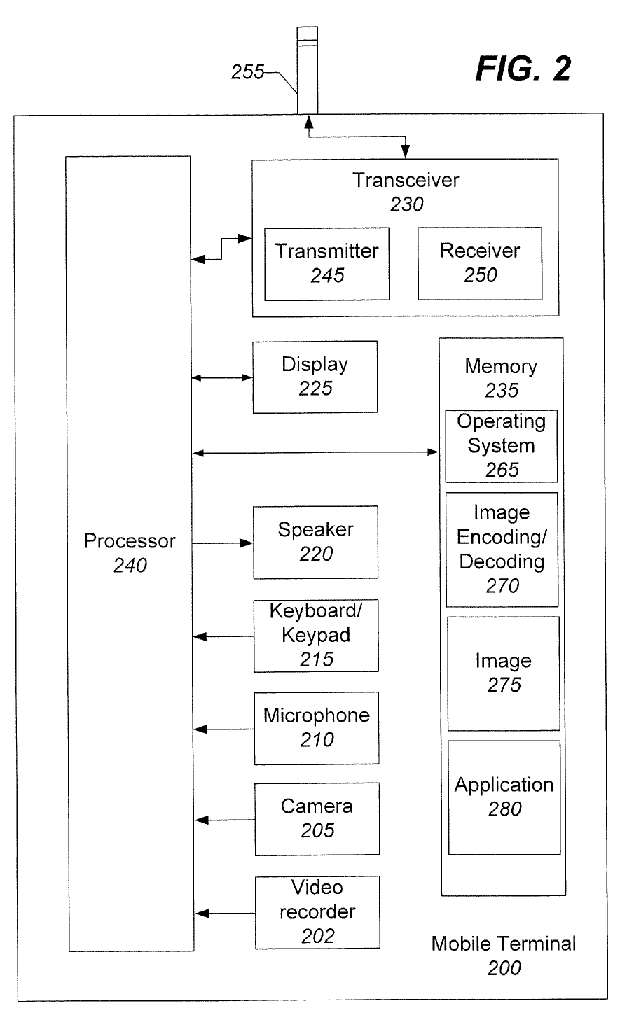

Referring now to FIG. 2, a mobile terminal 200 that can provide improved image encoding/decoding, in accordance with some embodiments of the present invention, comprises a video recorder 202, a camera 205, a microphone 210, a keyboard/keypad 215, a speaker 220, a display 225, a transceiver 230, and a memory 235 that communicate with a processor 240. The transceiver 230 comprises a transmitter circuit 245 and a receiver circuit 250, which respectively transmit outgoing radio frequency signals to base station transceivers and receive incoming radio frequency signals from the base station transceivers via an antenna 255. The radio frequency signals transmitted between the mobile terminal 200 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The cellular transceiver 230 can be configured to encode/decode and control communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS). The foregoing components of the mobile terminal 200 may be included in many conventional mobile terminals and their functionality is generally known to those skilled in the art.

The processor 240 communicates with the memory 235 via an address/data bus. The processor 240 may be, for example, a commercially available or custom microprocessor. The memory 235 is representative of the one or more memory devices containing the software and data used to provide improved image encoding/decoding, in accordance with some embodiments of the present invention. The memory 235 may include, but is not limited to, the following types of devices: cache, ROM, PROM, EPROM, EEPROM, flash, SRAM, and DRAM.

As shown in FIG. 2, the memory 235 may contain up to four or more categories of software and/or data: the operating system 265, an image encoding/decoding module 270, an image module 275, and an application module 280. The operating system 265 generally controls the operation of the mobile terminal 200. In particular, the operating system 265 may manage the mobile terminal's software and/or hardware resources and may coordinate execution of programs by the processor 240.

The image encoding/decoding module 270 may be configured to receive image files and then to encode the received image files using an encoding technique that is less complex to decode than the technique used to encode the original image files. For example, the image encoding/decoding module 270 may encode a JPEG image file using Ericsson Texture Compression (ETC), which is less complex to decode than the original JPEG image file. The original image file and the encoded image file may be associated with one another and stored in the memory 235. When a request to browse and image file or view a thumbnail of an image file, for example, is received, the image encoding/decoding module 270 may decode the encoded version of the image file, which is associated with the original image file, for presentation on a display. Because the encoded image file is less complex to decode that the original image file, decoding the encoded image file may be faster than decoding the original image file, which may be useful for applications that benefit from relatively fast decoding and presentation. Moreover, according to some embodiments of the present invention, an encoding technique, such as ETC, can be used that does not require additional and/or special hardware to perform the encoding/decoding. Instead, the encoding/decoding operations can be performed via software executed by a processor. Nevertheless, in other embodiments, the encoding/decoding module 270 may be implemented via one or more hardware components that carry out the operations of the software that execute on a processor.

The image module 275 may represent that images and encoded versions thereof that are respectively associated with one another. In some embodiments, an encoded version of an image may be stored in a metadata tag field of the original image file. For example, the original image may be stored using the EXIF file format and the encoded version of the image may be stored in the MakerNote tag field of the original image EXIF file. In other embodiments, the encoded version of an image may be stored in a data structure and/or database separate from the original image file along with information identifying the original image file to which it is connected.

The application module 280 may represent that various application programs that execute on the mobile terminal 200. For example, the application module 280 may represent email, Internet browser, and/or other communication applications that allow the mobile terminal to receive images for viewing on the mobile terminal. In addition, the application module 280 may represent image viewing and/or browsing applications that allow a user to view the images 275 in their original form, view thumbnail versions, browse through multiple images using, for example, touch screen technology, and the like.

Although FIG. 2 illustrates an exemplary software and hardware architecture that may be used to provide the mobile terminal 200 as shown in FIG. 2, it will be understood that the present invention is not limited to such a configuration, but is intended to encompass any configuration capable of carrying out the operations described herein.

Computer program code for carrying out operations of devices and/or systems discussed above with respect to FIGS. 1-2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, and/or computer program products in accordance with some embodiments of the invention. These flowchart and/or block diagrams further illustrate exemplary operations of electronic devices that can provide image encoding/decoding methods and computer program products for operating the same. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow, flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

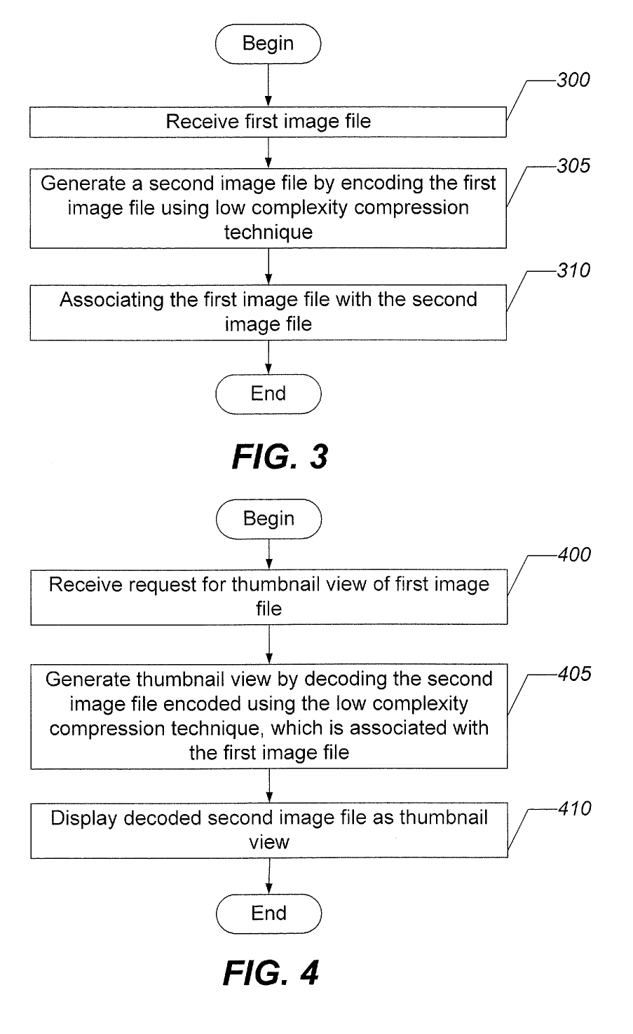

FIG. 3 is a flowchart that illustrates image encoding operations of the electronic device 100/mobile terminal 200 of FIGS. 1 and 2, respectively, in accordance with some embodiments of the present invention. Referring now to FIG. 3, operations begin at block 300 where a first image file is received. As discussed above, the image file may be, but is not limited to, a JPEG file, TIFF file, and/or RIFF file. At block 305 a second image file is generated by encoding the first image file using an encoding technique such that it is less complex to decode the second image file than it is to decode the first image file. In some embodiments, the encoding technique may be a compression technique, such as ETC. The ETC technique has been designed to be decodable with low complexity hardware. Accordingly, the attributes that allow ETC files to be decodable using low complexity hardware may also allow ETC files to be decoded using software that executes on a processor. The first image file is then associated with the second, encoded, image file at block 310. In accordance with various embodiments of the present invention, the first image file and second, encoded, image file may be logically associated with one another and/or physically associated with one another, such as, for example, being stored as part of the same file. As discussed above, in some embodiments, the second, encoded image file may be stored in a metadata tag field of the first image. In other embodiments, the second, encoded image file may be stored in a data structure and/or database separate from the first image file along with information identifying the first image file to which it is connected.

FIG. 4 is a flowchart that illustrates image decoding operations of the electronic device 100/mobile terminal 200 of FIGS. 1 and 2, respectively, in accordance with some embodiments of the present invention. Referring now to FIG. 4, operations begin at block 400 where a request is received to view the encoded version of an image, such as a request to browse the image, view a thumbnail version of the image, or the like, which is associated with an original image. This request may be received through various types of applications running on electronic device 100/mobile terminal 200. The encoded version of the image is then decoded at block 405 to generate, for example, a thumbnail version of the original image for display. At block 410, the decoded version of the image may be displayed, for example, using a thumbnail view.

Conventional electronic devices using, for example, 208 MHz ARM9 processor hardware can take approximately 120 ms to decode a JPEG thumbnail image to screen size. Indeed, image decoding may be the largest bottleneck for quick photo browsing. For devices that offer touch screen browsing of images, expensive hardware may be used to achieve the image decoding speeds necessary to support such browsing applications. Some embodiments of the present invention may allow the decoding of an ETC thumbnail image to screen size in approximately 15 ms using 208 MHz ARM9 processor hardware. As discussed above, encoding/decoding of ETC images can be performed using software that executes on a processor and/or via relatively inexpensive hardware. Moreover, ETC may provide the ability to generate a “rough” representation of an image in less than 5 ms using 208 MHz ARM9 processor hardware, which may be useful for rapid browsing of images responsive to swipes of a touch screen, for example.

The flowcharts of FIGS. 3 and 4 illustrate the architecture, functionality, and operations of embodiments of electronic devices, methods, and/or computer program products for providing improved encoding/decoding of images. In this regard, each block may represent a module, segment, or portion of code, which comprises one or more executable instructions for implementing the specified logical function(s). It should also be noted that in other implementations, the operation(s) noted in the messages may occur out of the order noted in FIG. 3. For example, two blocks shown in succession may, in fact, be executed substantially concurrently or the blocks may sometimes be executed in the reverse order, depending on the functionality involved.

In the drawings and specification, there have been disclosed embodiments of the invention and, although specific terms are used, they are used in a generic and descriptive sense only and not for purposes of limitation, the scope of the invention being set forth in the following claims.

That which is claimed:

1. A method of operating an electronic device, comprising:
receiving a first image file;
generating a second image file by encoding the first image file using an encoding technique such that it is less complex to decode the second image file than it is to decode the first image file; and
associating the first image file with the second image file.

2. The method of claim 1, wherein the electronic device comprises a camera and wherein receiving the first image file comprises:
taking a picture with the camera, the picture being output from the camera as the first image file.

3. The method of claim 1, wherein receiving the first image file comprises receiving the first image file via a communication connection established between the electronic device and another entity.

4. The method of claim 1, wherein the first image file is encoded using Joint Photographic Experts Group (JPEG) encoding.

5. The method of claim 1, wherein the encoding technique used to generate the second image file is Ericsson Texture Compression (ETC) encoding.

6. The method of claim 1, wherein associating the first image file with the second image file comprises storing the first image file using a file format having a metadata tag for storing the second image file.

7. The method of claim 6, wherein the file format is the Exchangeable Image File Format (EXIF) and the metadata tag is the MakerNote tag.

8. The method of claim 1, wherein associating the first image file with the second image file comprises storing the second image file in a data structure and/or database that comprises a reference to the first image file.

9. The method of claim 1, further comprising:
receiving a request for a thumbnail view of the first image file; and
generating the thumbnail view of the first image file by decoding the second image file.

10. The method of claim 1, wherein the electronic device is a mobile terminal.

11. A computer program product for operating an electronic device, comprising:
a computer readable storage medium having computer readable program code embodied therein, the computer readable program code being configured to carry out the method of claim 1.

12. An electronic device, comprising:
a processor configured to receive a first image file, generate a second image file by encoding the first image file using an encoding technique such that it is less complex to decode the second image file than it is to decode the first image file, and to associate the first image file with the second image file.

13. The electronic device of claim 12, further comprising:
a camera;
wherein the processor is further configured to take a picture with the camera, the picture being output from the camera as the first image file.

14. The electronic device of claim 12, wherein the processor is further configured to receive the first image file via a communication connection established between the electronic device and another entity.

15. The electronic device of claim 12, wherein the first image file is encoded using Joint Photographic Experts Group (JPEG) encoding.

16. The electronic device of claim 12, wherein the encoding technique used to generate the second image file is Ericsson Texture Compression (ETC) encoding.

17. The electronic device of claim 12, wherein the processor is further configured to store the first image file using a file format having a metadata tag for storing the second image file.

18. The electronic device of claim 17, wherein the file format is the Exchangeable Image File Format (EXIF) and the metadata tag is a MakerNote tag.

19. The electronic device of claim 17, wherein the processor is further configured to receive a request for a thumbnail view of the first image file and to generate the thumbnail view of the first image file by decoding the second image file.

20. The electronic device of claim 12, wherein the electronic device is a mobile terminal.
